(19) United States
(12) Patent Application Publication
(10) Pub. No.: US 2004/0058066 A1
(43) Pub. Date: Mar. 25, 2004

(54) Thin film of metal oxide and a method for preparing it

(76) Inventors: Zhiqiang Wei, Ibaraki-shi (JP); Minoru Noda, Suita-shi (JP); Masanori Okuyama, Toyonaka-shi (JP)

Correspondence Address: BIRCH STEWART KOLASCH & BIRCH, PO BOX 747, FALLS CHURCH, VA, 22040-0747, US

(21) Appl. No.: 10/665,496

(22) Filed: Sep. 22, 2003

(30) Foreign Application Priority Data
Sep. 20, 2002 (JP) 2002-276399

(51) Int. Cl. B05D 3/02

(52) U.S. Cl. 427/226; 427/377

(57) ABSTRACT

The present invention relates to a method for preparing a thin film of metal oxide containing one or more metal elements on a substrate. The method includes the steps of applying a sol-gel solution containing the one or more metal elements to a surface of the substrate, drying the sol-gel solution to prepare a dried gel film on the substrate, soaking the dried gel film on the substrate in an alkaline aqueous solution containing at least one kind of metal element among the one or more metal elements in a container, sealing the container, and performing hydrothermal treatment for the dried gel film on the substrate in the sealed container to prepare a thin film of metal oxide on the substrate.

### BACKGROUND OF THE INVENTION

1. Field of the Invention

The present invention relates to a thin film of metal oxide and a method for preparing the thin film of metal oxide.

2. Description of the Related Art

Complex oxides such as barium titanate (BaTiO₃:BTO) and barium strontium titanate (Ba_{X}Sr_{1-X}TiO₃:BST) are expected for application of a highly integrated dynamic random access memory (DRAM), since they have a high relative dielectric constant. Thin films of such complex oxides have been prepared by various methods such as metal organic chemical vapor deposition (MOCVD), sputtering, and spin coating.

However, the above-mentioned methods require a temperature of 500° C. or higher to prepare a thin film, and this restricts fabrication processes of semiconductor devices. For example, it is impossible to form the thin film of the complex oxides after forming aluminum wires on a semiconductor substrate.

As a method to resolve the issues as described above, the present inventors have described a method for preparing a BTO thin film at a temperature of about 400° C. (Japanese Journal of Applied Physics, Vol. 39 (July, 2000), p. 4217-4219, titled “Low-temperature Crystallization of Metal Organic Decomposition BaTiO₃ Thin Film by Hydrothermal Annealing”).

However, it is desired to prepare a thin film of metal oxide including complex oxides at a lower temperature. Further, it is desired for the development of devices to use these methods.

### SUMMARY OF THE INVENTION

It is an object of the present invention to prepare the thin film of metal oxide at a lower temperature and to provide the thin film of metal oxide prepared thereby.

A method of the present invention for preparing a thin film of metal oxide containing one or more metal elements on a substrate, includes the steps of: (a) applying a sol-gel solution containing the one or more metal elements to a surface of the substrate; (b) drying the sol-gel solution to prepare a dried gel film on the substrate; (c) soaking the dried gel film on the substrate in an alkaline aqueous solution containing at least one kind of metal element among the one or more metal elements in a container; (d) sealing the container; and (e) performing hydrothermal treatment for the dried gel film on the substrate in the sealed container to prepare the thin film of metal oxide on the substrate.

A first thin film of metal oxide according to the present invention is prepared by the above-mentioned method for preparing a thin film. The first thin film has substantially no carbon that is contained in the dried gel film before the hydrothermal treatment.

A second thin film of metal oxide according to the present invention is prepared by the above-mentioned method for preparing a thin film. When a voltage of 2V is applied to this second thin film, a leakage current in this second thin film is 10⁻⁷ A/cm² or less.

A third thin film of metal oxide according to the present invention is prepared by the above-mentioned method for preparing a thin film. A relative dielectric constant of this third thin film is 20 or higher.

A capacitor according to the present invention includes a thin film of metal oxide prepared by the above-mentioned method for preparing a thin film as a dielectric.

A memory according to the present invention includes a capacitor which includes a thin film of metal oxide prepared by the above-mentioned method for preparing a thin film as a dielectric.

An advantage of the method according to the present invention is that a thin film of metal oxide can be prepared at a lower temperature.

An advantage of the thin film of metal oxide obtained by the method according to the present invention is that its characteristics can be improved.

### BRIEF DESCRIPTION OF THE DRAWINGS

Additional objects and advantages of the present invention will be apparent from the following detailed description of preferred embodiments thereof, which are best understood with reference to the accompanying drawings.

FIG. 1 is a flow chart of a method for preparing a barium titanate (BTO) thin film according to the present invention.

FIG. 2 is a sectional view of a hydrothermal treatment apparatus used in a method for preparing a thin film according to the present invention.

FIG. 3 is a graph of X-ray diffraction (XRD) patterns of the thin film obtained by the method for preparing a thin film according to the present invention.

FIG. 4 is a graph of X-ray photoelectron spectroscopy (XPS) spectra of the thin film obtained by the method for preparing a thin film according to the present invention.

FIG. 5 is a graph of a leakage current in the thin film obtained by the method for preparing a thin film according to the present invention.

FIG. 6 is a sectional view of DRAM including a highly dielectric thin film.

FIG. 7 is a flow chart of a method for fabricating DRAM by using the method for preparing a thin film according to the present invention.

FIG. 8 is a flow chart of a method for preparing a barium strontium titanate (BST) thin film according to the present invention.

### DESCRIPTION OF THE PREFERRED EMBODIMENTS

Preparing a-thin film according to the present invention is characterized in that a sol-gel technique is combined with a hydrothermal treatment technique. Hereinafter, by way of example, preparation of a BTO thin film and a BST thin film will be described.

A. Preparation of a BTO Thin Film

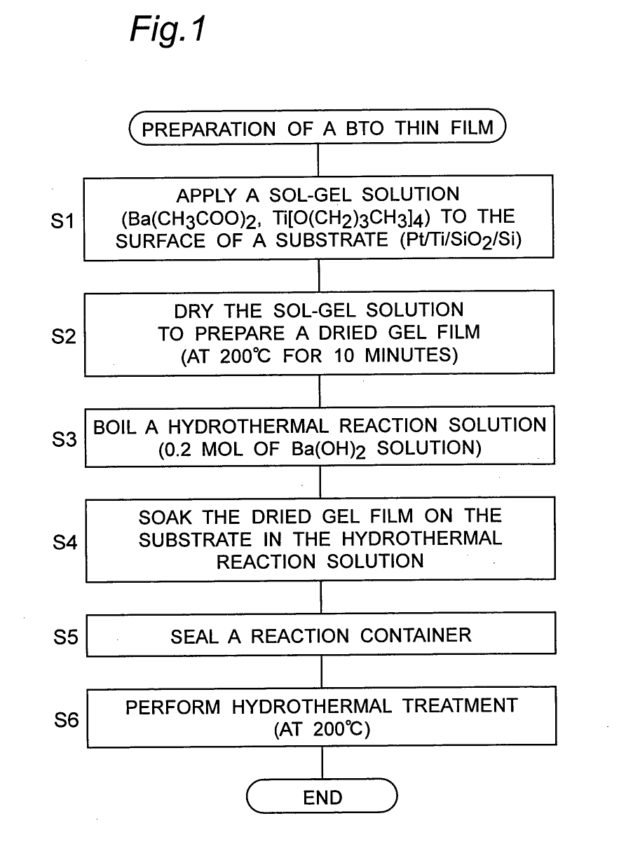

FIG. 1 shows a flow chart of a method for preparing a barium titanate (BTO) thin film according to this embodiment. First, a sol-gel solution (a solution as the starting material in a sol-gel method) including barium acetate (Ba(CH₃COO)₂) and titanium tetrabutoxide (Ti[O(CH₂)₃CH₃]₄) is applied to the surface of a substrate (step S1). Here, the substrate is a Pt/Ti/SiO₂/Si substrate configured by layering silicon oxide (SiO₂), titanium (Ti) and platinum (Pt) on silicon (Si) in this order. The thicknesses of SiO₂, Ti and Pt layers are 1 μm, 20 nm and 200 nm, respectively. The sol-gel solution is applied to the surface of the substrate by spin coating. In this case, the sol-gel solution is dropped onto the surface of the substrate, and the substrate wetted with the solution is rotated, for example, at a speed of 500 rpm (revolutions per minute) for three seconds and then at a speed of 4,000 rpm for 15 seconds. This sol-gel solution may be applied to the substrate by using another method such as dipping.

Next, the sol-gel solution applied to the substrate is dried (step S2). For example, the substrate is placed in an oven, and the sol-gel solution on the substrate is retained at 200° C. for ten minutes in the atmosphere. Thereby, a dried gel film is produced on the substrate.

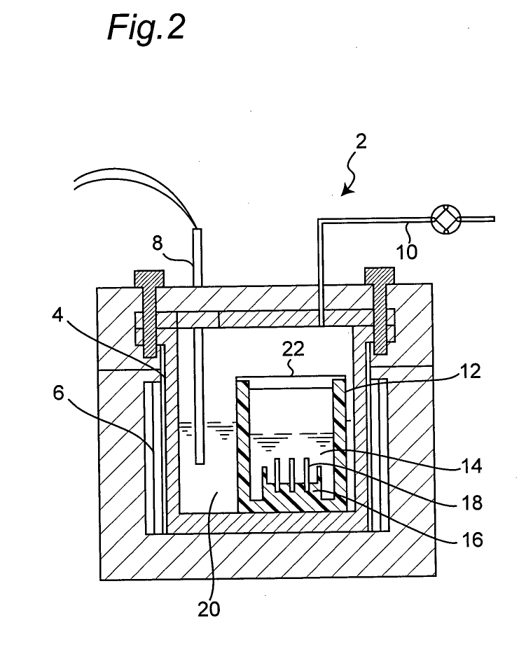

Next, hydrothermal treatment is performed for the dried gel film on the substrate. Hereinafter, this treatment is described in detail. FIG. 2 shows a hydrothermal treatment apparatus (autoclave) used in the method for preparing a BTO thin film according to this embodiment. As shown in FIG. 2, the hydrothermal treatment apparatus 2 includes a sealed stainless steel container 4 and a heater 6 which heats the stainless steel container 4 externally. The stainless steel container 4 is equipped with a thermocouple 8 for detecting a temperature of liquid in the container 4 and a leak tube 10 for reducing a pressure in the container 4.

The stainless steel container 4 has a container made of Teflon® (Teflon® beaker) 12 therein. A hydrothermal reaction solution 14 is put in the beaker 12. The beaker 12 has a substrate holder 16 at the bottom thereof, which allows to hold a substrate 18 subject to hydrothermal treatment and to properly soak the substrate 18 in the hydrothermal reaction solution 14. Deionized water 20 is put in a portion which surrounds the beaker 12 in the stainless steel container 4.

In the method for preparing the BTO thin film according to this embodiment, the hydrothermal reaction solution 14 is deionized water containing 0.2 mol of barium hydroxide (Ba(OH)₂), which is an alkaline aqueous solution. First, the hydrothermal reaction solution 14 is boiled before the hydrothermal treatment (Step 3). In particular, 30 ml of the hydrothermal reaction solution 14 is put in the beaker 12, and then boiled before the beaker 12 is placed in the stainless steel container 4. By boiling, carbon dioxide (CO₂) dissolved in the hydrothermal reaction solution 14 is eliminated to prevent hydroxides in the solution 14 from carbonizing. This boiling process allows the thin film, produced by the hydrothermal treatment, to be low in carbon content and therefore to be higher in quality.

After boiling the-hydrothermal reaction solution 14, the substrate 18 processed in step S2 (having the dried gel film) is attached to the substrate holder 16 in the beaker 12 and is soaked in the hydrothermal reaction solution 14 (step S4). That is, the dried gel film on the substrate is soaked in the hydrothermal reaction solution. Then, the lid 22 is put on the beaker 12. Next, the beaker 12 is placed in the stainless steel container 4, and then the stainless steel container (reaction container) 4 is sealed (step S5).

Next, the sealed container 4 is heated with the heater 6, and an internal temperature of the sealed container 4 is set to 200° C. Here, since the sealed container 4 contains the deionized water 20, an internal pressure of the sealed container 4 becomes equal to a saturated vapor pressure of the deionized water 20. The saturated vapor pressure of water at 200° C. is about 15 atm. Accordingly, the hydrothermal treatment is performed with the internal temperature and the internal pressure of the sealed container 4 set to 200° C. and to 15 atm, respectively, in the hydrothermal treatment apparatus 2 (step S6).

By performing the hydrothermal treatment for ten hours in step S6, a thin film having a film thickness of 200 nm is prepared on the substrate. A relative dielectric constant ε of the thin film is measured to be 20.Further, the thin film having the relative dielectric constant of 20 or higher can be also attained in a similar manner.

According to the method for preparing a thin film of this embodiment, crystallization temperature of the dried gel film (a precursor thin film) can be reduced by reacting hydroxide ions (OH⁻) of the hydrothermal reaction solution with organic compounds of the gel film on the surface of the substrate under a-high pressure.

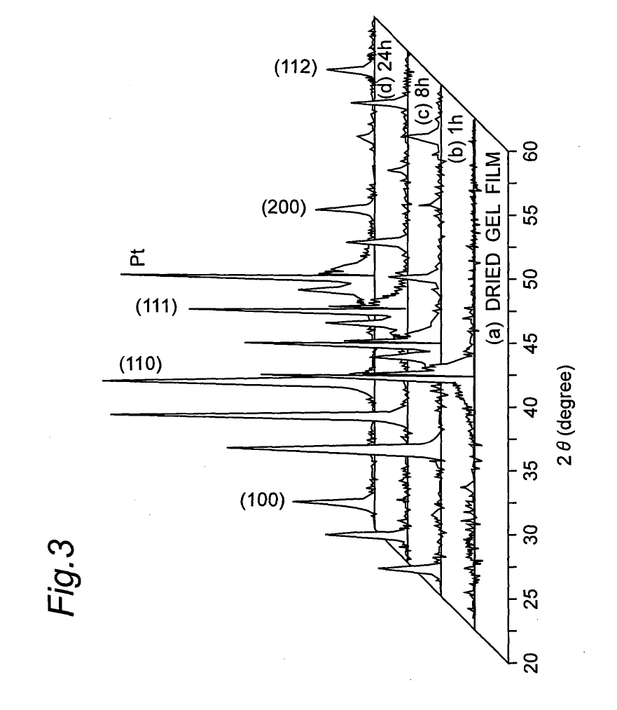

FIG. 3 shows X-ray diffraction (XRD) patterns of the thin film prepared by the above-mentioned method (from step S1 to S6). In FIG. 3, there are shown that the XRD patterns of the thin film vary with the passage of the hydrothermal treatment time (0, 1, 8, and 24 hours). As shown in FIG. 3, the peaks of crystal faces (100), (110), (200), and (112) are found in the diffraction patterns (c) and (d) of the thin film obtained after the hydrothermal treatment of at least eight hours, while those peaks are not found in the diffiraction pattern (a) of the dried gel film obtained before the hydrothermal treatment. This means that a perovskite phase of BTO, not present in the dried gel film, is produced by the hydrothermal treatment. The intensity of the peak of the crystal face (110) increases with the passage of the treatment time, and is saturated when the treatment time exceeds eight hours. Therefore, it is thought that eight hours are necessary and sufficient as the hydrothermal treatment time in the method for preparing a thin film according to this embodiment.

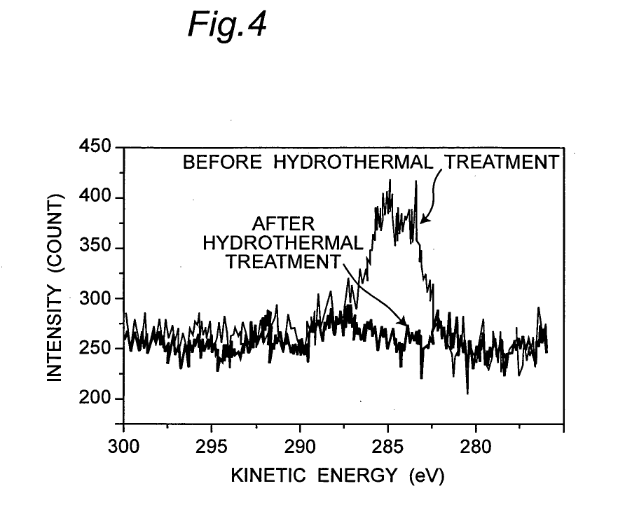

FIG. 4 shows X-ray photoelectron spectroscopy (XPS) spectra of the dried gel film obtained before the hydrothermal treatment and the BTO thin film obtained after the hydrothermal treatment of at least eight hours, which indicate carbon contents of these films. As shown in FIG. 4, a peak representing the presence of carbon (C) in the spectrum of the dried gel film (represented by a thin line) disappears in the spectrum of the BTO thin film (represented by a bold line). This means that the carbon contained in the dried gel film is disappeared by a hydrothermal treatment process (steps S3 to S6). According to the method for preparing a thin film of this embodiment, a thin film which is significantly low in the carbon content and high in quality can be obtained.

Further, although the internal temperature of the sealed container is set to 200° C. in the hydrothermal treatment according to the method for preparing a thin film of this embodiment, it may be set to any temperature within a range of 120 to 374° C. since a temperature at which a thin film of high quality is produced can be present within that range. In addition, another condition such as the concentration of the hydrothermal reaction solution can be changed depending on the internal temperature. According to the method for preparing a thin film of this embodiment, it is possible to prepare a thin film when the internal temperature of the sealed container is set to a temperature within the range of 120 to 374° C. in the hydrothermal treatment. Further, the internal temperature is preferably set to a temperature within the range of 120 to 300° C. to obtain the thin film having a sufficient film thickness. Additionally, the internal temperature is preferably set to a temperature within the range of 140 to 240° C. to obtain the thin film of high quality.

Further, although an acetate (barium acetate) and a metal alkoxide (titanium tetrabutoxide) are employed as the material of the sol-gel solution used in step S1 according to the method for preparing a thin film of this embodiment, the material of the sol-gel solution is not limited to these. It may be, for example, two kinds of metal alkoxides (barium alkoxide and titanium alkoxide) or a double-alkoxide containing titanium and barium together. Further, it may be another sol-gel solution, in which barium (Ba) and titanium (Ti) are dissolved.

Further, although a treatment cycle consisting of a sol-gel (SG) process (steps S1 and S2) and a hydrothermal treatment (H) process (steps S3 to S6) is performed once according to the method for preparing a thin film of this embodiment, it may be performed twice (that is, SG process, H process, SG process and H process may be performed in this order). Even when the treatment cycle is performed twice, it is possible to obtain BTO thin film having high quality with the low carbon content as well as when the treatment cycle is performed once.

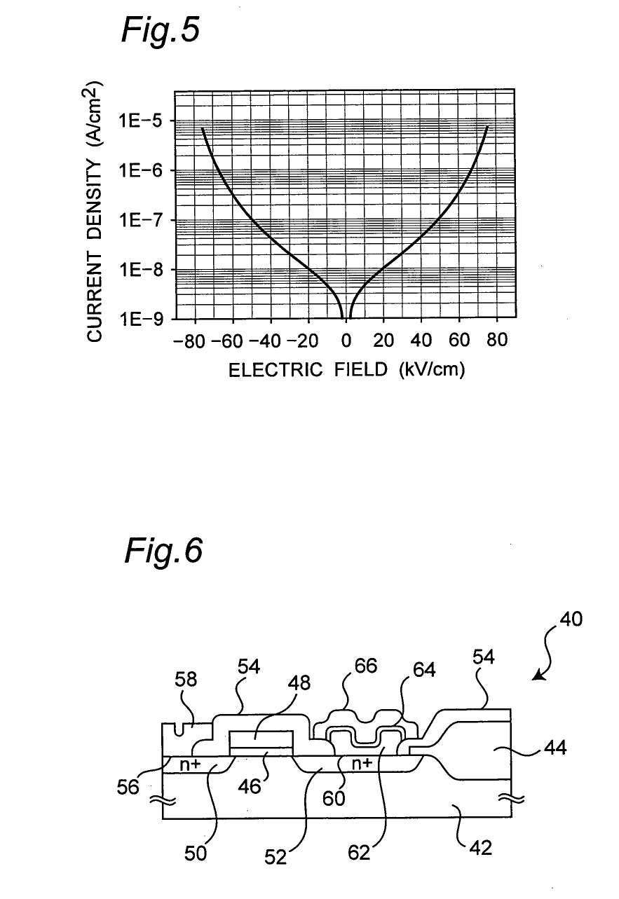

FIG. 5 shows a leakage current in the BTO thin film obtained by performing the treatment cycle twice as described above (the hydrothermal treatment time is ten hours in each cycle). As shown in FIG. 5, the leakage current in the thin film is, for example, 9.56×10⁻⁸ A/cm² at ±2V (the value of a voltage is obtained by converting the value of an electric field (kV/cm) as shown in FIG. 5). Thus, the thin film obtained by performing the treatment cycle twice can be considered to have good insulation characteristics. According to the method for preparing a thin film of this embodiment, it is possible to prepare the BTO thin film having good insulation characteristics. And, it is also possible to prepare the thin film in which the leakage current is 10⁻⁷ A/cm² or less when a voltage of 2V is applied to the thin film.

Further, these characteristics of the smallness of the leakage current are very favorable as a highly dielectric material used for a storage capacitor of a highly integrated DRAM. Hereinafter, a method for fabricating the highly integrated DRAM by using the method for preparing a thin film according to this embodiment will be described. FIG. 6 shows a sectional view of the DRAM, to show an example of the structure of the DRAM. The DRAM 40 includes a silicon substrate 42, a field oxide 44 grown on the silicon substrate 42, a gate oxide (gate insulator) 46 formed on the silicon substrate 42, a gate electrode 48 formed on the gate oxide 46, and a source region 50 and a drain region 52 formed on both sides of the gate electrode 48 in the silicon substrate 42. A bit line-58 is connected to the source region 50 through a contact hole 56 of an interlayer insulator 54. A lower electrode 62 of the capacitor is formed on the drain region 52 through a contact hole 60 of the interlayer insulator 54. And, a highly dielectric thin film 64 is formed on the lower electrode 62 and an upper electrode 66 is further formed on the highly dielectric thin film 64.

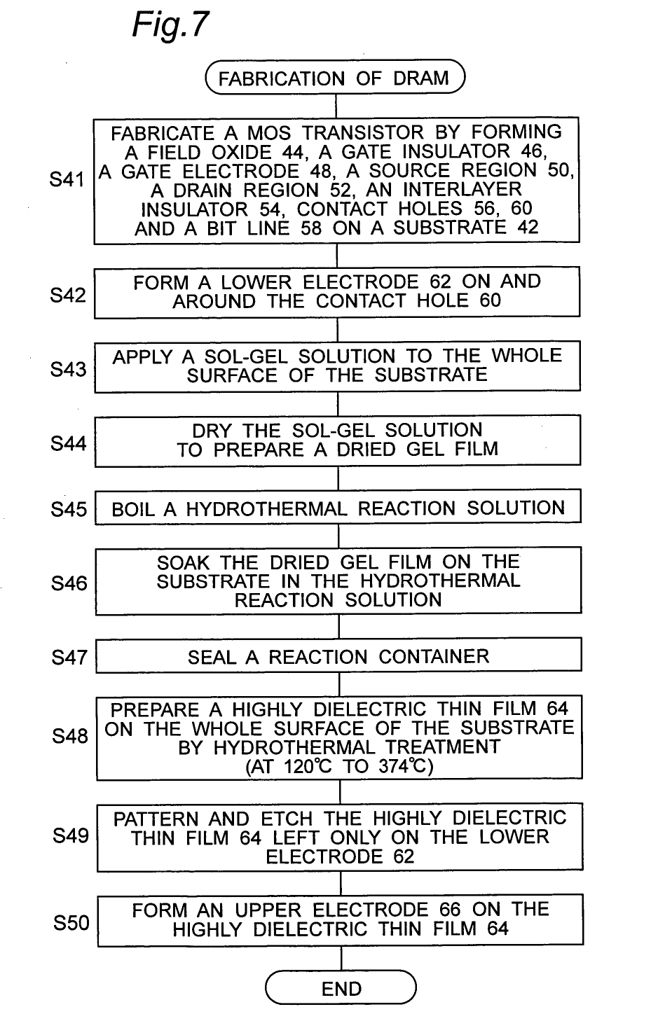

FIG. 7 is a simplified flow chart of a method for fabricating the DRAM shown in FIG. 6. As shown in FIG. 7, first, a metal oxide semiconductor (MOS) transistor is fabricated (step S41). In particular, first, the field oxide 44 is grown on the silicon substrate 42, and then the gate insulator 46 and the gate electrode 48 are formed in this order. Then, n-type impurities like phosphorus (P) are injected into the silicon substrate 42 on both sides of the gate electrode 48 to form the source region 50 and the drain region 52. Then, the interlayer insulator 54 is formed on the surface of the substrate 42. After patterning and etching, contact holes 56 and 60 are formed to expose the source region 50 and the drain region 52. Then, a bit line 58 made of an aluminum and the like is formed around the contact hole 56. As a result, a MOS transistor is fabricated. The fabrication of the MOS transistor (step S41) can be made by using any conventional method.

Next, the lower electrode 62 is formed on and around the contact hole 60 (step S42). This lower electrode 62 can be formed by using a conventional method for preparing a thin film.

Next, the sol-gel solution is applied to the whole surface of the substrate on which the MOS transistor and the lower electrode 62 are formed (step S43), and then the sol-gel solution is dried to prepare a dried gel film (step S44). Meanwhile, a hydrothermal reaction solution is boiled (step S45). Next, the whole substrate (having the dried gel film) is soaked in the hydrothermal reaction solution inside a reaction container (step S46). Then, the reaction container containing the substrate and the hydrothermal reaction solution therein is sealed (step S47). Next, the hydrothermal treatment is performed with the internal temperature of the sealed container set to a temperature within the range of 120 to 374° C. (step S48). According to those processes, the highly dielectric thin film 64 is formed on the whole surface of the substrate (that is, the highly dielectric thin film 64 is formed on the MOS transistor and the lower electrode 62). This process of preparing the highly dielectric thin film 64 (steps S43 to S48) is identical to the above-mentioned process of preparing the BTO thin film including the sol-gel process and the hydrothermal treatment process (FIG. 1). Next, the highly dielectric thin film 64, formed on the whole surface of the substrate, is patterned, and etched left only on the lower electrode 62 (step S49). Finally, the upper electrode 66 is formed on the highly dielectric thin film 64 (step S50).

In the method for fabricating DRAM described above (FIG. 7), the highly dielectric thin film of a capacitor is formed by using the method for preparing a thin film according to the present invention. Thus, the highly dielectric thin film can be prepared at a lower temperature at which a film is prepared than a conventional temperature. As a result, even after forming aluminum wires (bit line 58) on a substrate, the highly dielectric thin film can be formed on the same substrate.

B. Preparation of BST Thin Film

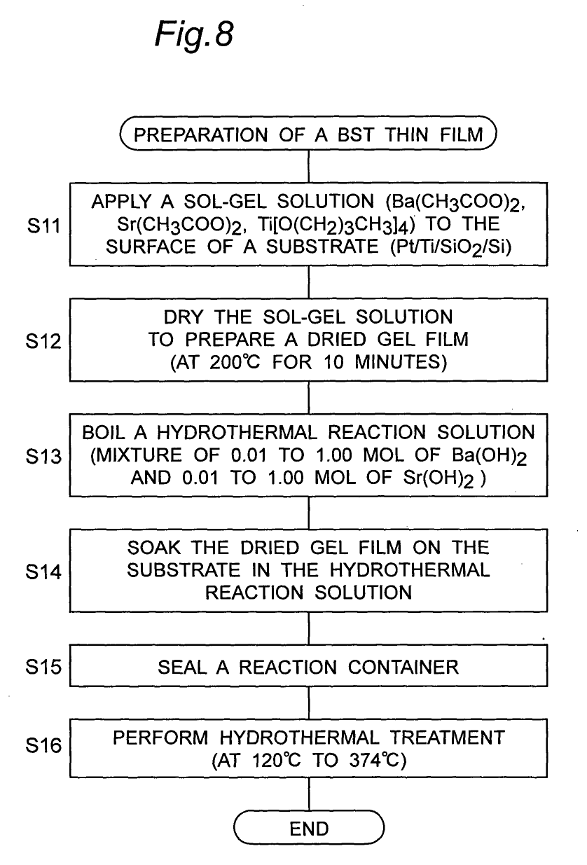

FIG. 8 shows a flow chart of a method for preparing a barium strontium titanate (BST) thin film according to this embodiment. First, a sol-gel solution including barium acetate (Ba(CH₃COO)₂), strontium acetate (Sr(CH₃COO)) and titanium tetrabutoxide (Ti[O(CH₂)₃CH₃]₄) is applied to the surface of a substrate of Pt/Ti/SiO₂/Si (step S11). Here, the substrate is a Pt/Ti/SiO₂/Si substrate configured by layering silicon oxide (SiO₂), titanium (Ti) and platinum (Pt) on silicon (Si) in this order. The thicknesses of SiO₂, Ti and Pt layers are 1 μm, 20 nm and 200 nm, respectively. The sol-gel solution is applied to the surface of the substrate by spin coating. In this case, the sol-gel solution is dropped onto the surface of the substrate, and the substrate wetted with the solution is rotated, for example, at a speed of 500 rpm for three seconds and then at a speed of 4,000 rpm for 15 seconds. This sol-gel solution may be applied to the substrate by using another method such as dipping.

Next, the sol-gel solution applied to the substrate is dried (step S12). For example, the substrate is placed in an oven, and the sol-gel solution on the substrate is retained at 200° C. for ten minutes in the atmosphere. Thereby, a dried gel film is produced on the substrate.

Next, hydrothermal treatment is performed for the dried gel film on the substrate. The hydrothermal treatment apparatus used for this hydrothermal treatment is that used in preparing the BTO thin film (FIG. 2). In the method for preparing the BST thin film according to this embodiment, the hydrothermal reaction solution 14 is deionized water containing 0.01 to 1.00 mol of barium hydroxide (Ba(OH)₂) and 0.01 to 1.00 mol of strontium hydroxide (Sr(OH)₂), which is an alkaline aqueous solution. First, the hydrothermal reaction solution 14 is boiled before the hydrothermal treatment (step S13). In particular, the hydrothermal reaction solution 14 is put in the Teflon® beaker 12, and then boiled before the beaker 12 is placed in the stainless steel container 4. By boiling, carbon dioxide (CO₂) dissolved in the hydrothermal reaction solution 14 is eliminated to prevent hydroxides in the solution 14 from carbonizing. This boiling process allows the thin film, produced by hydrothermal treatment, to be low in carbon content and therefore to be higher in quality.

After boiling the hydrothermal reaction solution 14, the substrate 18 processed in step S 12 (having the dried gel film) is attached to the substrate holder 16 in the beaker 12 and is soaked in the hydrothermal reaction solution 14 (step S 14). That is, the dried gel film on the substrate is soaked in the hydrothermal reaction solution. Then, the lid 22 is put on the beaker 12. Next, the beaker 12 is placed in the stainless steel container 4, and then the stainless steal container (reaction container) 4 is sealed (step S15).

Next, the sealed container 4 is heated with the heater 6, and an internal temperature of the sealed container 4 is set to a temperature within the range of 120 to 374° C. Here, since the sealed container 4 contains the deionized water 20, an internal pressure of the sealed container 4 becomes equal to a saturated vapor pressure of the deionized water 20. For example, the saturated vapor pressure of water at 200° C. is about 15 atm. Accordingly,. the hydrothermal treatment is, for example, performed with the internal temperature and the internal pressure of the sealed container 4 set to 200° C. and to 15 atm, respectively, in the hydrothermal treatment apparatus 2 (step S16).

According to the method for preparing a thin film of this embodiment, crystallization temperature of the dried gel film (a precursor thin film) can be reduced by reacting hydroxide ions (OH⁻) of the hydrothermal reaction solution with organic compounds of the gel film on the surface of the substrate under a high pressure.

Further, according to the method for preparing a thin film of this embodiment, it is possible to obtain the thin film which is significantly low in the carbon content and high in quality.

Further, although two kinds of acetates (barium acetate, strontium acetate) and a metal alkoxide (titanium tetrabutoxide) are employed as the material of the sol-gel solution used in the step S11 according to the method for preparing a thin film of this embodiment, the material of the sol-gel solution is not limited to these. It may be an acetate and two kinds of metal alkoxides. Further, it may be, for example, three kinds of metal alkoxides (barium alkoxide, strontium alkoxide and titanium alkoxide). In addition, the material of the sol-gel solution may include a double-alkoxide containing two kinds of metal elements. Further, another sol-gel solution, in which barium (Ba), strontium (Sr) and titanium (Ti) are dissolved, may be used.

The BST thin film prepared by the above-mentioned method can also be applied to a ferroelectric memory as a ferroelectric material besides a storage capacitor of a highly integrated DRAM. In addition, it can be applied to an infrared sensor because of its excellent dielectric constant-temperature characteristics. When this BST thin film is applied to the storage capacitor of the highly integrated DRAM, the DRAM can be fabricated with the fabrication process indicated in FIG. 7, where the BTO thin film is replaced with a BST thin film as the highly dielectric material.

In the above descriptions, the BTO thin film and the BST thin film are prepared by using the method for preparing a thin film according to the present invention, but thin films prepared by the method are not limited to them. A thin film of another complex oxide containing two or more kinds of metal elements can be prepared by the method. For example, the method for preparing a thin film according to the present invention can be applied to preparing the thin films of lead zirconate titanate (PbZrxTi_{1-X}O₃:PZT), strontium bismuth tantalate (SrBi₂Ta₂O₉:SBT), lanthanum antimonate (LaSbO₃) and the like. And, the method of the present invention can also be applied to preparing the thin films of metal oxides such as hafnium oxide (HfO₂), zirconium oxide (ZrO₂), praseodymium oxide (Pr₂O₃), aluminum oxide (Al₂O₃), and lanthanum oxide (La₂O₃) other than the complex oxides. Further, the thin film of metal oxide, having a high relative dielectric constant, prepared by the method for preparing a thin film according to the present invention can be used as the dielectric of a capacitor. Further, this capacitor can be applied to the memory such as DRAM.

It will be obvious to those having skill in the art that many changes may be made in the above-described details of the preferred embodiments of the present invention. The scope of the present invention, therefore, should be determined by the following claims.

What is claimed is:

1. A method for preparing a thin film of metal oxide containing one or more metal elements on a substrate, comprising the steps of:
applying a sol-gel solution containing said one or more metal elements to a surface of said substrate;
drying said sol-gel solution to prepare a dried gel film on said substrate;
soaking said dried gel film on said substrate in an alkaline aqueous solution containing at least one kind of metal element among said one or more metal elements in a container;
sealing said container; and
performing hydrothermal treatment for said dried gel film on said substrate in the sealed container to prepare said thin film of metal oxide on said substrate.

2. The method for preparing a thin film of metal oxide according to claim 1, wherein in said step of performing hydrothermal treatment, an internal temperature of said sealed container is set to a temperature of 374° C. or lower.

3. The method for preparing a thin film of metal oxide according to claim 2, wherein in said step of performing hydrothermal treatment, an internal temperature of said sealed container is set to a temperature of no lower than 140° C. and no higher than 240° C.

4. The method for preparing a thin film of metal oxide according to claim 1, further comprising the step of boiling said alkaline aqueous solution before said step of soaking.

5. The method for preparing a thin film of metal oxide according to claim 1, wherein said one or more metal elements contained in said metal oxide are barium and titanium;
said sol-gel solution comprises a barium acetate and a titanium alkoxide; and
said at least one kind of metal element contained in said alkaline aqueous solution is barium.

6. The method for preparing a thin film of metal oxide according to claim 1, wherein said one or more metal elements contained in said metal oxide are barium, strontium and titanium;
said sol-gel solution comprises a barium acetate, a strontium acetate, and a titanium alkoxide; and
said at least one kind of metal element contained in said alkaline aqueous solution are barium and strontium.

7. A thin film of metal oxide prepared by a method for preparing a thin film of metal oxide containing one or more metal elements on a substrate, which comprises the steps of:
applying a sol-gel solution containing said one or more metal elements to a surface of said substrate;
drying said sol-gel solution to prepare a dried gel film on said substrate;
soaking said dried gel film on said substrate in an alkaline aqueous solution containing at least one kind of metal element among said one or more metal elements in a container;
sealing said container; and
performing hydrothermal treatment for said dried gel film on said substrate in the sealed container to prepare said thin film of metal oxide on said substrate.

8. The thin film of metal oxide according to claim 7, wherein said thin film of metal oxide has substantially no carbon.

9. The thin film of metal oxide according to claim 7, wherein a leakage current in said thin film of metal oxide is 10⁻⁷ A/cm² or less when a voltage of 2V is applied to said thin film of metal oxide.

10. The thin film of metal oxide according to claim 7, wherein a relative dielectric constant of said thin film of metal oxide is 20 or higher.

11. A capacitor including a thin film of metal oxide containing one or more metal elements as a dielectric, wherein said thin film of metal oxide is prepared by a method for preparing a thin film of metal oxide containing one or more metal elements on a substrate, which comprises the steps of:
applying a sol-gel solution containing said one or more metal elements to a surface of said substrate;
drying said sol-gel solution to prepare a dried gel film on said substrate;
soaking said dried gel film on said substrate in an alkaline aqueous solution containing at least one kind of metal element among said one or more metal elements in a container;
sealing said container; and
performing hydrothermal treatment for said dried gel film on said substrate in the sealed container to prepare said thin film of metal oxide on said substrate.

12. A memory comprising a capacitor which includes a thin film of metal oxide containing one or more metal elements as a dielectric, wherein said thin film of metal oxide is prepared by a method for preparing a thin film of metal oxide containing one or more metal elements on a substrate, which-comprises the steps of:
applying a sol-gel solution containing said one or more metal elements to a surface of said substrate;
drying said sol-gel solution to prepare a dried gel film on said substrate;
soaking said dried gel film on said substrate in an alkaline aqueous solution containing at least one kind of metal element among said one or more metal elements in a container;
sealing said container; and
performing hydrothermal treatment for said dried gel film on said substrate in the sealed container to prepare said thin film of metal oxide on said substrate.
